(19) United States
(12) Patent Application Publication
(10) Pub. No.: US 2025/0367078 A1
(43) Pub. Date: Dec. 4, 2025

(54) ADVANCED CAPSULE SEGMENTS IN SOLID OR REWORK DESIGN

(71) Applicant: Innex Innovative Industries, Rochester, NY (US)

(72) Inventor: Thomas Blaszczykiewicz, Rochester, NY (US)

(21) Appl. No.: 19/221,462

(22) Filed: May 28, 2025

Related U.S. Application Data
(60) Provisional application No. 63/652,341, filed on May 28, 2024.

(51) Int. Cl. A61J 3/07

(52) U.S. Cl. CPC A61J 3/074

(57) ABSTRACT

Improved capsule segments for the holding, filling, compaction, and sealing of pharmacological capsules which include a steel base having one or more sleeve segments lined with one or more of ceramic, PTFE, metal-detectable ceramic, or another advanced material. When the lining material becomes worn it may be removed and replaced allowing the steel base to be returned to service.

### CROSS REFERENCE TO RELATED APPLICATIONS

This application claims priority to U.S. Provisional Patent Application No. 63/652,341 filed on May 28, 2024, which is incorporated herein by reference.

### FIELD

The claimed technology relates generally to pharmacological capsules and more particularly to devices and methods for holding, filling, and packing such capsules.

### BACKGROUND

Capsule segments are utilized in the production of capsules for use in the pharmaceutical, nutraceutical, and vitamin industries. They serve the purpose of holding the top and bottom portion capsules. These capsules are filled and sealed with active and non-active ingredients, typically a homogeneous powder mixture placed into a capsule container that is used to produce an oral pharmaceutical, nutraceutical, vitamin, or other supplements, and/or over the counter or prescribed medication in pill or capsule form. The capsule segments hold the capsules while they are being filled, packed with a tamping pin, and then sealed with powders or granulations commonly used by pharma companies in a high-volume production line.

Current segments are made of tool steel and are not ideal for holding, filling, and packing capsules, often with abrasive, sticky, and corrosive ingredients, into the capsule. Steel is soft and porous and steel can oxidize and rust as well. The cell structure of steel is large and gets soiled easily allowing for the growth of bacteria which is highly problematic for companies producing capsules. Additionally, once the steel segment is worn it cannot be reused and disposed of. This technology requires improvement.

### SUMMARY

In one aspect, an improved capsule segment block for a capsule filling machine having an upper block body portion including a plurality of capsule chambers having an open end and a closed end portion connected by a sidewall portion, the sidewall portion and closed end portion being covered with a lining portion, and a lower block body portion including a plurality of capsule chambers having an open end and a closed end portion connected by a sidewall portion, the sidewall portion and closed end portion being covered with a lining portion, where the upper block body portions are made from steel and the lining portions are made from one of ceramic, metal-detectible ceramic, PTFE, and combinations thereof. Optionally, the metal-detectable ceramic materials include metallic particles having magnetic permeability of at least about 1×10−4 H/m and relative magnetic permeability of at least about 8000. In another example, the lining portion is a removable insert layer whereas in other examples it is a coating.

In another aspect, a method of reconditioning a capsule segment block for a capsule filling machine is provided by removing a worn capsule segment block from service, the capsule block segment having a steel block body portion including a plurality of capsule chambers having an open end and a closed end connected by a sidewall portion, the sidewall portion and closed end being covered with a protective lining portion, next removing the protective lining portion from the steel block body portion (by mechanical means or heat), optionally inspecting the steel block body portion for damage and repairing any such damage, next applying a new protective lining portion to the steel block body portion to create a reconditioned capsule segment block, and finally returning the reconditioned capsule segment block to service. In some examples the protective lining portions are made from one of ceramic, metal-detectible ceramic, PTFE, and combinations thereof. In other examples the protective lining portions are removable inserts. In still other examples, the protective lining portions are made from a metal-detectible ceramic which includes metallic particles having magnetic permeability of at least about 1×10−4 H/m and relative magnetic permeability of at least about 8000.

In a further aspect an improved capsule segment block for a capsule filling machine is provided having a block body portion including a plurality of capsule chambers having an open end and a closed end portion connected by a sidewall portion and a lining portion covering the closed end portion and the sidewall portion. Optionally, the improved capsule segment block of claim 8 wherein the block body portion is made of a metal-detectible ceramic. In other examples, the improved capsule segment block of claim 8 wherein the block body portion is made of steel and the lining portion is made of ceramic, PTFE, and combinations thereof. Ins till other examples the block body portion is made of steel and the lining portion is made of a metal-detectible ceramic. Optionally, the metal-detectable ceramic includes metallic particles having magnetic permeability of at least about 1×10−4 H/m and relative magnetic permeability of at least about 8000. In still further examples, the lining portion is a removable insert layer.

### BRIEF DESCRIPTION OF THE DRAWINGS

FIG. 1 is a top plan view of one example of capsule segment blocks according to the disclosed technology.

FIG. 2 is a partial cross sectional view of one example of an upper sleeve in a capsule segment block according to the disclosed technology.

FIG. 3 is a partial cross sectional view of one example of an lower sleeve in a capsule segment block according to the disclosed technology corresponding to the upper sleeve shown in FIG. 2.

FIG. 4 is a partial cross sectional view of another example of an upper sleeve in a capsule segment block according to the disclosed technology.

FIG. 5 is a partial cross sectional view of another example of an lower sleeve in a capsule segment block according to the disclosed technology corresponding to the upper sleeve shown in FIG. 4.

FIG. 6 is a top plan and partial cross sectional view of another example of an upper capsule segment block according to the disclosed technology.

FIG. 7 is a top plan and partial cross sectional view of another example of a lower capsule segment block according to the disclosed technology corresponding to the upper capsule segment block of FIG. 6.

FIG. 8 is an example of a capsule segment block reconditioning method according to the disclosed technology.

### DESCRIPTION

For the purposes of promoting an understanding of the principles of the claimed technology and presenting its currently understood best mode of operation, reference will now be made to the embodiments illustrated in the drawings and specific language will be used to describe the same. It will nevertheless be understood that no limitation of the scope of the claimed technology is thereby intended, with such alterations and further modifications in the illustrated device and such further applications of the principles of the claimed technology as illustrated therein being contemplated as would normally occur to one skilled in the art to which the claimed technology relates.

The disclosed invention include advanced capsule segment designs utilized in the production of capsules for use in the pharmaceutical, nutraceutical, and vitamin industries. They serve the purpose of holding the top and bottom portion capsules during the filling, compaction, and sealing portions of the capsule production process. These capsules are filled and sealed with active and non-active ingredients, typically a homogeneous powder mixture placed into a capsule container that is used to produce an oral pharmaceutical, nutraceutical, vitamin, or other supplement composition, and/or over the counter or prescribed medication in pill or capsule form. The disclosed improved capsule segments address the need for more efficient materials and design technology for holding the capsules while they are being filled, packed with a tamping pin, and then sealed with powders or granulations commonly used by pharma companies in a high-volume production line.

Encapsulation is used primarily when a simple powder cannot be compacted easily with tablet press, particularly at higher production rates. The capsule or container provide both an active and an inactive ingredient for people requiring a specific dosage to help treat, manage, or cure an ailment, disease, pain, respiratory, pain management or supplementing low vitamins or nutrients that would otherwise negatively affect the patient. Obtaining the proper dosage in a capsule is important to ensure the consumer does not receive an overdose or underdose that could have serious health repercussions. Hence, ensuring the capsule is processed correctly is vital. A clean and properly filled capsule is needed; product sticking, high wear or corrosive tools can result in incorrect loading that can have unintended consequences.

Today's capsule packing companies face difficult challenges as the sticking powders are packed into capsules held in metal segments which causes a high rate of friction and as a result powders get stuck in the pores of the steel which increases as the steel wears. As the powder sticks to the upper and lower capsule segments, it creates a problem with capsules getting stuck leading to variations in quality, scrap rates and shut down for maintenance. These quality issues further significantly increase the chances that improperly filled capsules will be sold to customers which can cause severe health issues caused by the over or under dosage factor.

The novel improved capsule segments disclosed herein utilize ceramic, metal-detectable ceramic (such as taught in U.S. Pat. No. 9,670,101), PTFE and/or other composite materials and combinations hereof that provide improved antistick and lower friction in addition to improved wear properties as well as anti-rust and corrosion resistance. Below is a general overview of the tribological properties of Ceramic, PTFE, and polished stainless steel (with a 4 Ra surface finish):

### Ceramic

Friction Coefficient: Ceramics can have a wide range of friction coefficients depending on the type of ceramic and the conditions. Ceramics can have very low coefficients (similar to PTFE),.
Wear Resistance: High performance ceramics are very wear-resistant, much more so the PTFE and stainless steel, especially in abrasive conditions or under high load.

### PTFE

Friction Coefficient: PTFE is known for its low friction coefficient, typically in the range of 0.05 to.020 under various conditions.
Wear Resistance: While PTFE has low friction, its wear resistance is not as high as some other materials. It can wear out faster under high load or abrasive conditions.

### Stainless Steel (Polished to a 4 Ra Finish)

Friction Coefficient: The friction coefficient of stainless steel is higher than PTFE or ceramics.
Wear Resistance: Stainless steel is higher than PTFE but is lower than ceramic.

The novel improved capsule segments designs disclosed herein are versatile and can be produced in a number of ways to accommodate varied customer needs and price points. These novel designs include a solid ceramic option as well as reworkable composite designs such as a steel base with sleeved lined segments of either ceramic, PTFE, or another advanced material, a steel base holder with interchangeable segment blocks made of either ceramic, PTFE or another advanced material and finally a ceramic or metal-detectable ceramic coated steel base. The metallic phase of suitable metal-detectible ceramics may be an alloy, and the alloy may be introduced as metal alloy particles, particles of oxidized alloy, or as oxides of the constituent metals for reduction and subsequent alloying of the resulting metals. The metallic phase typically has a high magnetic permeability μ of at least about 1×10⁻⁴ H/m with a relative permeability μ/μₒ of at least about 100, more typically u being at least about 5×10⁻³ H/m and μ/μₒ at least about 4000, still more typically μ being at least about 1×10⁻² H/m and μ/μₒ at least about 8000, and yet more typically μ being about 2.5×10⁻² H/m and μ/μₒ 20,000. In some cases, μ/μo may exceed 50,000. In other cases the metallic phase typically has a high magnetic permeability μ of at least about 1×10⁻⁴H/m with a relative permeability μ/μₒ of at least about 8000.

Capsule segments interface with the potentially sticky, abrasive, corrosive, and/or moisture containing fill materials necessitating the need for improved tribology over traditional stainless steel capsule segments. The specialized materials used for the improved capsule segment designs disclosed herein all provide improved tribology, reduce both friction and wear when polished at a 4 Ra resulting in a more lubricated surface. Ceramic does not oxidize or corrode. This novel tooling has the desirable properties to significantly reduce the negative effects of sticky and abrasive fill powders. This reduces the need for tooling changes, excessive cleaning, potential line shutdowns, and/or producing defective capsule products and ensures safer dosage filling. The improved accuracy and reduced waste also contribute to the advantages of this novel technology.

Some of the disclosed novel improved capsule segments have been designed to be reworked and not simply disposed of like the traditional, one life steel design. Once a segment sleeve, block or coating has worn the steel base may still have viability allowing the steel base to be reworked, recoated with one of the composite and/or ceramic materials disclosed herein, and the capsule segment returned to service. In one example, a worn steel base is heated up until the steel expands, the ceramic sleeve, block or coating is removed and replaced with new Ceramic, PTFE, or other advanced material that also provides a reduction in friction, has great wear and corrosion resistance as well. They are then machined, polished and ready for return to service.

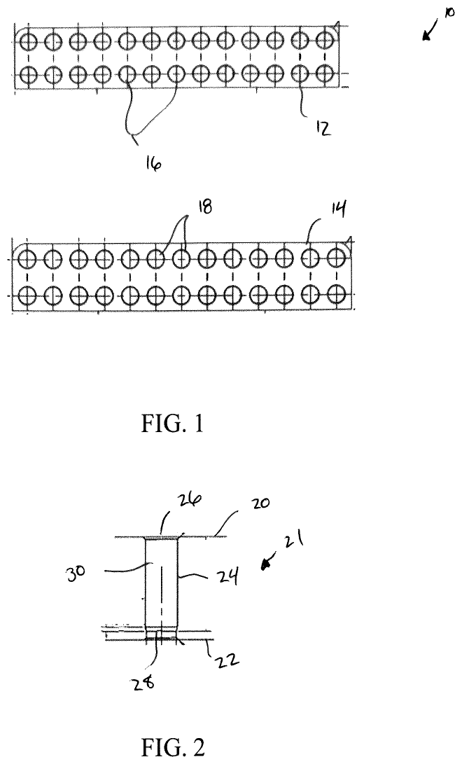

FIG. 1 shows a top plan view of improved capsule segment blocks 10 according to one example of the disclosed technology. In this particular example the capsule segment blocks 10 include an upper block portion 12 and a lower block portion. The upper block portion 12 and lower block portion 14 each include a plurality of capsule chambers 16, 18 which correspond to one another. The number of capsule chambers may vary as desired from example to example. In practice, capsule portions which typically include a larger capsule portion and a smaller capsule portion are disposed in the capsule chambers 16, 18 of the associated block portion 12, 14. Typically the larger capsule portion is filled with the desired amount of product (powder, oil, liquid, and the like), optionally compacted with a tamping pin, the upper and lower block portions 12, 14 are then brought together so as to join the two capsule halves together to form a capsule. The individual capsules are then sealed using a suitable sealing method such as pressure, ultrasonic welding, heat, and the like and the finished capsules ejected.

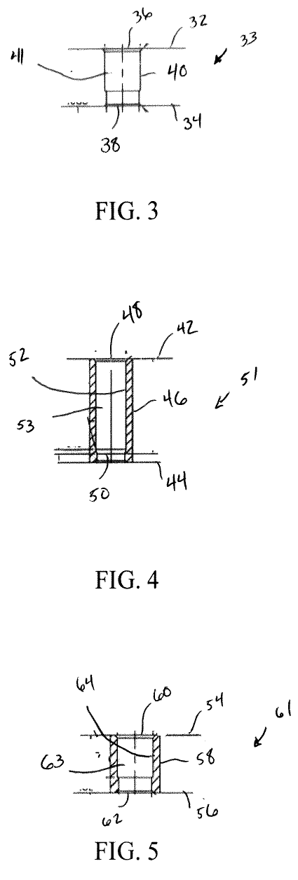

FIGS. 2-3 show a partial cross sectional view of one example of an upper capsule sleeve 21 and a lower capsule sleeve 33. In this particular example, the upper sleeve 21 is disposed in an upper block portion between a first block surface 20 and a second block surface 22 and includes a chamber 30 defined by a side wall portion 24, a lower wall portion 28, and an opening 26 disposed on the first block surface 20. The chamber 30 is sized and configured to hold a capsule portion (not shown) during the filling process. The lower sleeve 33 is disposed in an lower block portion between a first block surface 32 and a second block surface 34 and includes a chamber 41 defined by a side wall portion 40, a lower wall portion 38, and an opening 36 disposed on the first block surface 32. The chamber 41 is sized and configured to hold a capsule portion (not shown) during the filling process. In this particular example, the upper block portion 21 and lower block portion 33 are made from a ceramic material, optionally a metal-detectible ceramic material, PTFE, and combinations thereof.

FIGS. 4-5 show a partial cross sectional view of one example of an upper capsule sleeve 51 and a lower capsule sleeve 61. In this particular example, the upper sleeve 51 is disposed in an upper block portion between a first block surface 42 and a second block surface 44 and includes a chamber 53 defined by a side wall portion 46, a lower wall portion 50, and an opening 48 disposed on the first block surface 42. The chamber 53 is sized and configured to hold a capsule portion (not shown) during the filling process. The upper block portion in this example is made from steel meaning the side wall portion 46 and lower wall portion 50 are also steel. A lining layer 52 covers the side wall portion 46 and lower wall portion 50 which provides the chamber 53 with a lining layer between the steel body of the upper block portion and any capsule body disposed therein. This lining layer 52 may be made from a ceramic, a metal-detectible ceramic, PTFE, and combinations thereof.

Continuing with FIGS. 4-5, the lower sleeve 61 is disposed in a lower block portion between a first block surface 54 and a second block surface 56 and includes a chamber 63 defined by a side wall portion 58, a lower wall portion 62, and an opening 60 disposed on the first block surface 54. The chamber 63 is sized and configured to hold a capsule portion (not shown) during the filling process. The lower block portion in this example is made from steel meaning the side wall portion 58 and lower wall portion 62 are also steel. A lining layer 64 covers the side wall portion 58 and lower wall portion 62 which provides the chamber 63 with a lining layer between the steel body of the lower block portion and any capsule body disposed therein. This lining layer 64 may be made from a ceramic, a metal-detectible ceramic, PTFE, and combinations thereof.

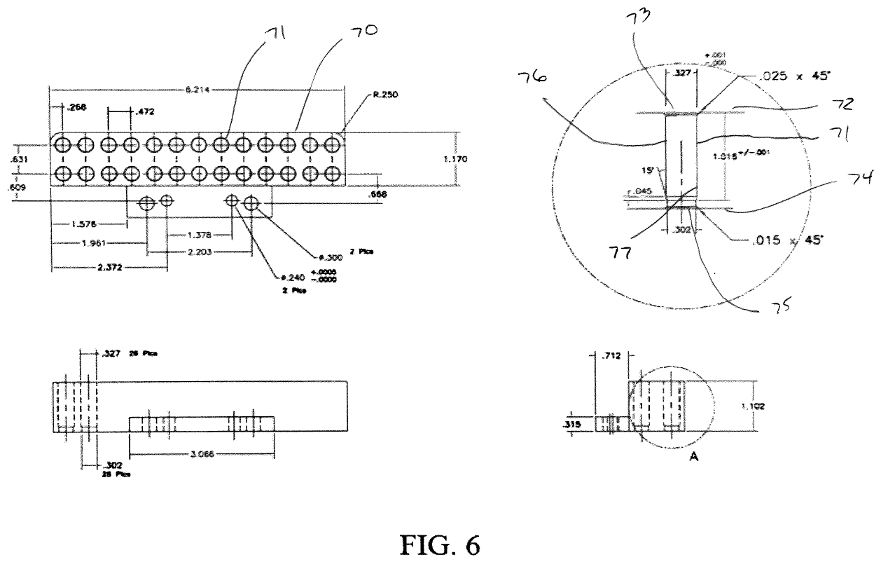

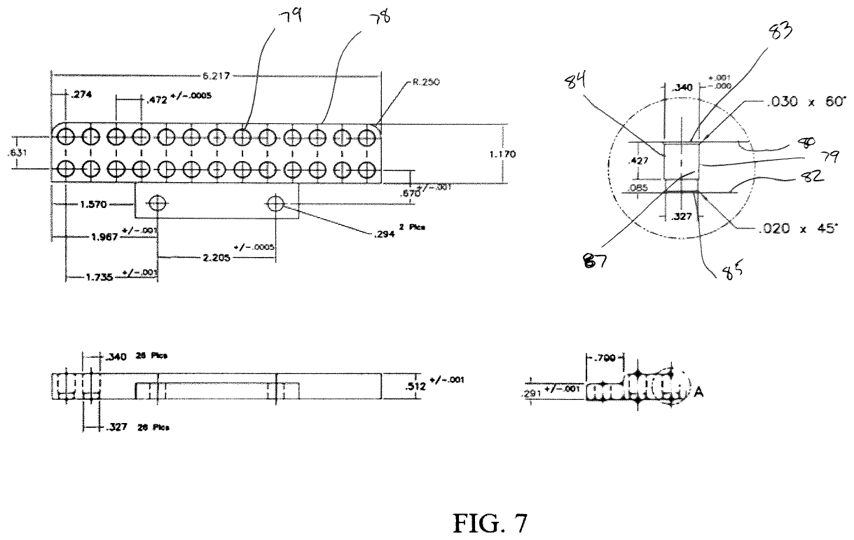

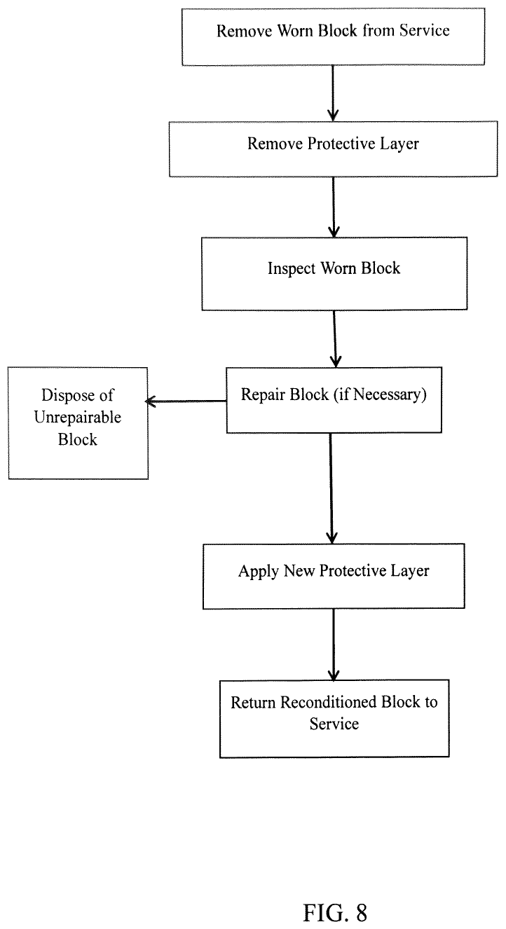

FIGS. 6-7 show yet another example of the disclosed technology in which a steel upper block portion 70 and lower block portion 78 include a plurality of capsule chambers 71, 79 defined by a sidewall (76, 84) disposed between a first block surface 72, 80 (defined by an opening 73, 83) and second block surface 74, 82 (defined by a closed bottom portion 75, 85). The capsule chambers further include a coating 77, 87 which covers the sidewall 76, 84 and the closed bottom portion 75, 85. The coating may be made from a ceramic, a metal-detectible ceramic, PTFE, and combinations hereof.

The improved capsule segment blocks disclosed herein will eventually wear after prolonged use. Unlike traditional steel/metal capsule segment blocks which must be disposed of when sufficiently worn, the improved capsule segment blocks of the disclosed technology may be reconditioned and put back into service. In one example, a worn capsule block is removed from service and sent in for reconditioning, the protective layer or capsule chamber lining is removed such as by heat, mechanical means, or combinations thereof. The remaining metal block body is then inspected and resurfaced/repaired as necessary, or disposed of/recycle if sufficiently damaged. The metal block body then has a new protective layer or lining applied. The exact means required to reapply the protective layer will vary depending on the block composition, the composition of the protective layer to be applied (ceramic, metal-detectible ceramic, PTFE, and combinations thereof), as well as the type of protective layer being applied (sleeve insert or coating). Once the protective layer has been reapplied to the block body the reconditioned block body may be returned to service.

While the claimed technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the claimed technology are desired to be protected.

What is claimed is:

1. An improved capsule segment block for a capsule filling machine, comprising:
an upper block body portion including a plurality of capsule chambers having an open end and a closed end portion connected by a sidewall portion, the sidewall portion and closed end portion being covered with a lining portion; and
a lower block body portion including a plurality of capsule chambers having an open end and a closed end portion connected by a sidewall portion, the sidewall portion and closed end portion being covered with a lining portion;
wherein the upper block body portion are made from steel;
wherein the lining portions are made from one of ceramic, metal-detectible ceramic, PTFE, and combinations thereof.

2. The improved capsule segment block of claim 1 wherein the metal-detectable ceramic includes metallic particles having magnetic permeability of at least about 1×10⁻⁴ H/m and relative magnetic permeability of at least about 8000.

3. The improved capsule segment block of claim 1 wherein the lining portion is a removable insert layer.

4. A method of reconditioning a capsule segment block for a capsule filling machine, comprising:
removing a worn capsule segment block from service, the capsule block segment having a steel block body portion including a plurality of capsule chambers having an open end and a closed end connected by a sidewall portion, the sidewall portion and closed end being covered with a protective lining portion;
removing the protective lining portion from the steel block body portion;
inspecting the steel block body portion for damage;
applying a new protective lining portion to the steel block body portion to create a reconditioned capsule segment block; and
returning the reconditioned capsule segment block to service.

5. The method of claim 4, wherein the protective lining portions are made from one of ceramic, metal-detectible ceramic, PTFE, and combinations thereof.

6. The method of claim 4, wherein the protective lining portions are removable inserts.

7. The method of claim 4, herein the protective lining portions are made from a metal-detectible ceramic which includes metallic particles having magnetic permeability of at least about 1×10⁻⁴ H/m and relative magnetic permeability of at least about 8000.

8. An improved capsule segment block for a capsule filling machine, comprising:
a block body portion including a plurality of capsule chambers having an open end and a closed end portion connected by a sidewall portion;
a lining portion covering the closed end portion and the sidewall portion.

9. The improved capsule segment block of claim 8 wherein the block body portion is made of a metal-detectible ceramic.

10. The improved capsule segment block of claim 8 wherein the block body portion is made of steel and the lining portion is made of ceramic, PTFE, and combinations thereof.

11. The improved capsule segment block of claim 8 wherein the block body portion is made of steel and the lining portion is made of a metal-detectible ceramic.

12. The improved capsule segment block of claim 11 wherein the metal-detectable ceramic includes metallic particles having magnetic permeability of at least about 1×10⁻⁴ H/m and relative magnetic permeability of at least about 8000.

13. The improved capsule segment block of claim 8 wherein the lining portion is a removable insert layer.
